(19) United States
(12) Patent Application Publication
(10) Pub. No.: US 2009/0251806 A1
(43) Pub. Date: Oct. 8, 2009

(54) LENS ACTUATOR

(75) Inventors: TAI-HSU CHOU, Tu-Cheng (TW); CHIA-HUNG LIAO, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignee: HON HAI PRECISION INDUSTRY CO., LTD., Tu-Cheng (TW)

(21) Appl. No.: 12/240,439

(22) Filed: Sep. 29, 2008

(30) Foreign Application Priority Data
Apr. 2, 2008 (CN) 200810300818.X

(51) Int. Cl. G02B 7/02

(52) U.S. Cl. 359/823

(57) ABSTRACT

A lens actuator for driving a lens to move includes a lens barrel for accommodating the lens, a coil warped around the lens barrel, a fixed barrel, the lens barrel being received in and linearly movable relative to the fixed barrel, a plate shaped body including a through hole defined in a center thereof and a peripheral portion around the through hole, the flat spring plate's peripheral portion being fixed to one end of the fixed barrel. The fixed barrel is comprised of a permanent magnetic material.

### CROSS REFERENCE TO RELATED APPLICATION

This application is related to commonly-assigned co-pending application Ser. No. 12/192376, entitled “resilient plate and lens actuator with same”. Disclosure of the above-identified application is incorporated herein by reference in its entirety.

### BACKGROUND

1. Technical Field

The present invention generally relates to lens actuators, and particularly to a voice coil motor type lens actuator and a fixing unit in the actuator.

2. Description of Related Art

Variable focal length lenses are widely used in optical systems. Optical systems incorporating such lenses can, for example, provide focused images of objects at varying distances without adjusting the distance between the lens and the image plane. Variable focal length lenses can also be used in optical systems that provide varying magnification without change of lenses.

Generally, the optical system usually includes an actuator, such as a stepping motor, to drive the lenses. However, the step motor is relatively large in volume. Use of the step motor requires a significant amount of space for movement of the lenses, which makes the optical system bulky.

Therefore, what is needed is a lens actuator adapted for driving the lenses with more compact structure and less mechanical movement.

### SUMMARY

A lens actuator for driving a lens to move includes a lens barrel for accommodating the lens, a coil warped around the lens barrel, a fixed barrel, the lens barrel being received in and linearly movable relative to the fixed barrel, a plate shaped body including a through hole defined in a center thereof and a peripheral portion around the through hole, the flat spring plate's peripheral portion being fixed to one end of the fixed barrel. The fixed barrel is comprised of a permanent magnetic material.

### BRIEF DESCRIPTION OF THE DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawings, like reference numerals designate corresponding parts throughout the several views.

FIG. 1 is a schematic, isometric view of a lens actuator according to an exemplary embodiment, the lens actuator including a fixed barrel and a flat spring plate.

FIG. 2 is an exploded view of the lens actuator in FIG. 1.

FIG. 3 is a schematic, isometric view of the fixed barrel in FIG. 2.

FIG. 4 is a schematic, isometric view of the flat spring plate in FIG. 2.

### DETAILED DESCRIPTION OF THE EMBODIMENTS

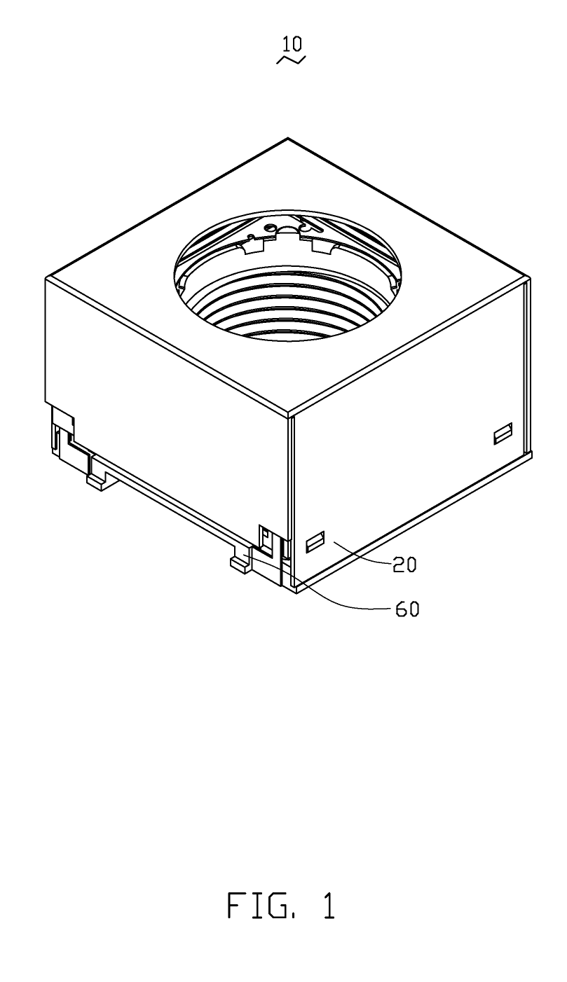

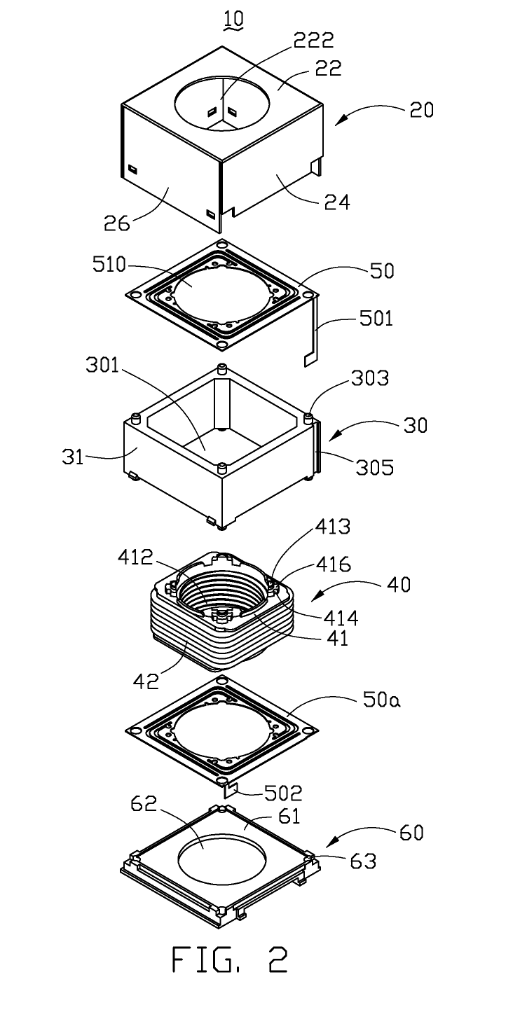

Referring to FIGS. 1 and 2, a lens actuator 10, in accordance with an exemplary embodiment, includes a housing 20, a fixed barrel 30, a movable unit 40, two flat spring plates (50, 50a), and a board 60.

The housing 20 includes a roof plate 22, a through hole 222 defined in the center of the roof plate 22, two opposite first side plates 24 and two opposite second side plates 26 respectively perpendicularly extending from the four peripheral sides of the roof plate 22 and fastened to one another by a dovetail panel joint (not shown). The roof plate 22, the first side plates 24, and the second side plates 26 cooperatively define a cavity for accommodating the fixed barrel 30. The housing 20 may be made of electromagnetic shield material, such as ferronickel alloy, electrically conductive plastic, surface conductive material, electrically conductive glass, etc.

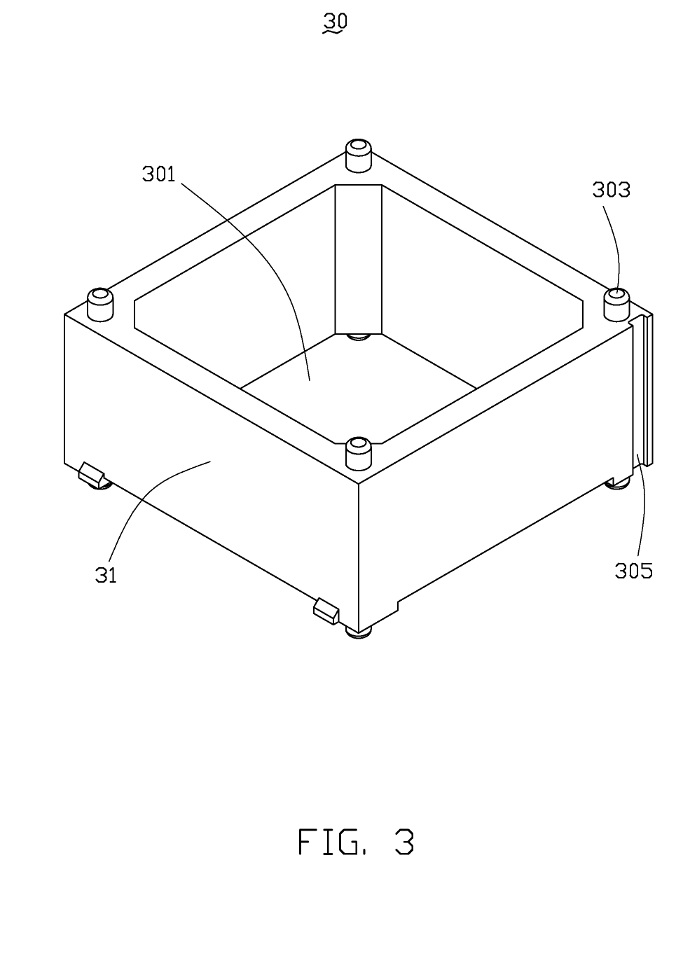

The fixed barrel 30 may be made of (refer to FIG. 3) a permanent magnetic material, such as NdFeB alloy, Samarium-Cobalt Alloy, Alnico, etc. The fixed barrel 30 is configured to be received in the housing 20 and comprises a main body 31. In this embodiment, the shape of a cross section of the main body 31 is square.

The shape of the cross section of the main body 31 may be round, triangle, pentagon or hexagon, etc.

A first accommodation room 301 is defined in the main body 31. Four first locating pins 303 are respectively vertically protruded from the top and bottom sides of the main body 31 at each corner thereof. The first locating pins 303 are configured for locating and fastening the fixed barrel 30 to both the flat spring plate plates (50, 50a). A terminal groove 305 is formed on the outer wall of the main body 31.

Referring to FIG. 2, the movable unit 40 includes a lens barrel 41 and coils 42. The movable unit 40 is accommodated in the first accommodating room 301 and may be movable relative to the fixed barrel 30. The lens barrel 41 defines a second accommodating room 412 for accommodating lenses and filters (not shown). The second accommodating room 412 is a through hole. Four convex stages 416 are respectively protruded from the top and bottom sides of the lens barrel 41 at each corner thereof. A second locating pin 413 is protruded from the top surface of the each of the convex stage 416. Two grooves 414 are defined on an outer sidewall of each convex stage 416. The grooves 414 are configured for receiving an adhesive material therein. The two flat spring plates (50, 50a) are respectively glued (i.e., adhesively mounted) to the top and bottom sides of the lens barrel 41 by adhesive, so as to respectively link the two flat spring plates with the lens barrel 41. The coils 42 are warped around the outer wall of the lens barrel 41.

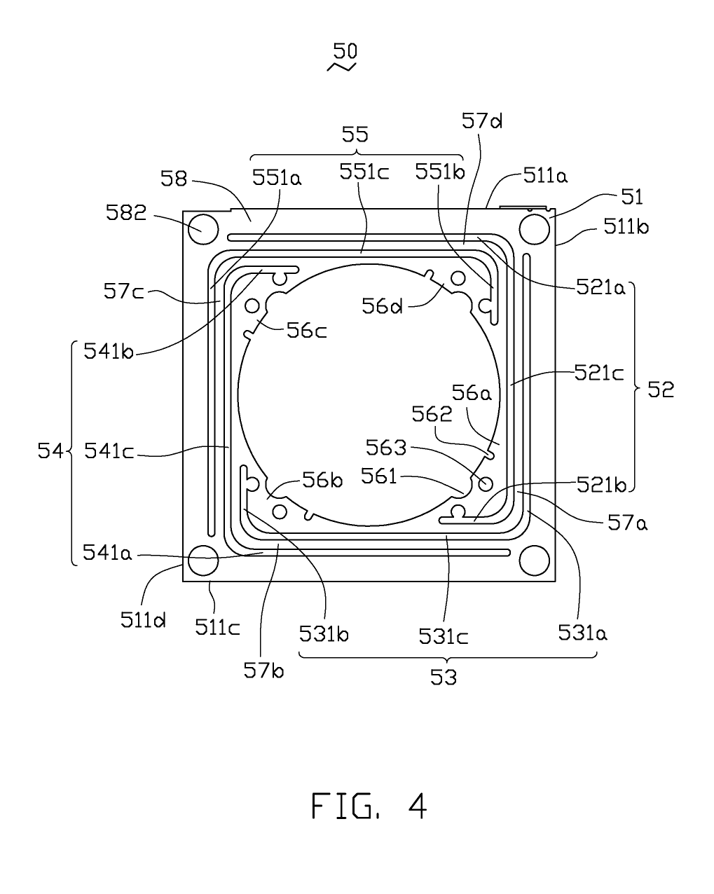

Referring to FIG. 4, the first flat spring plate 50 comprises a plate shaped body 51. In the present embodiment, the shape of the plate shaped body 51 is quadrate. The plate shaped body 51 includes a first edge 511a, a second edge 511b, a third edge 511c, and a fourth edge 511d. The first edge 511a is parallel to the third edge 511c, and the second edge 511b is parallel to the fourth edge 511d. A second through hole 510 for light passing therethrough is defined at the center of the plate shaped body 51. A first slot 52, a second slot 53, a third slot 54 and a fourth slot 55 are defined in the plate shaped body 51 around the second through hole 510. The slots (52, 53, 54, 55) are oriented about 90 degrees with respect to each other.

The first slot 52 includes a first starting portion 521a, a first ending portion 521b, and a first connecting portion 521c. The first starting portion 521a is parallel to the first edge 511a. The first ending portion 521b is parallel to the third edge 511c. The first connecting portion 521c is parallel to the second edge 511b and connected with the first starting portion 521a and the first ending portion 521b. The length of the first ending portion 521b is less than or equal to that of the first starting portion 521a. A first fixing portion 56a is formed between the second through hole 510 and the angular part or space between the first ending portion 521b and the first connecting portion 521c.

The second slot 53 includes a second starting portion 531a, a second ending portion 531b, and a second connecting portion 531c. The second starting portion 531a is parallel to the second edge 511b. The second ending portion 531b is parallel to the fourth edge 511d. The second connecting portion 531c is parallel to the third edge 511c and connected with the second starting portion 531a and the second ending portion 531b. The length of the second ending portion 531b is less than or equal to that of the second starting portion 531a. A second fixing portion 56b is formed between the second through hole 510 and the angular part or space between the second ending portion 531b and the second connecting portion 531c. The second starting portion 531a and the second connecting portion 531c are on the outer side of the first slot 52, i.e., the second starting portion 531a and the second connecting portion 531c are closer to the second edge 511b and the third edge 511c than the first slot 52. A first L-shaped spring portion 57a is arranged between the first slot 52 and the second slot 53. The spring portion 57a has a uniform width throughout the length thereof. Since the L-shaped spring portion 57a has an angular part or space, the durability and flexibility of the first flat spring plate 50 is enhanced.

The third slot 54 includes a third starting portion 541a, a third ending portion 541b, and a third connecting portion 541c. The third starting portion 541a is parallel to the third edge 511c. The third ending portion 541b is parallel to the first edge 511a. The third connecting portion 541c is parallel to the fourth edge 511d and connected with the third starting portion 541a and the third ending portion 541b. The length of the third ending portion 541b is less than or equal to that of the third starting portion 541a. A third fixing portion 56c is formed between the second through hole 510 and the angular part or space between the third ending portion 541b and the third connecting portion 541c. The third starting portion 541a and the third connecting portion 541c are on the outer side of the second slot 53, i.e., the third starting portion 541a and the third connecting portion 541c are closer to the third edge 511c and the fourth edge 511d than the second slot 53. A second L-shaped spring portion 57b is formed between the second slot 53 and the third slot 54.

The fourth slot 55 includes a fourth starting portion 551a, a fourth ending portion 551b, and a fourth connecting portion 551c. The fourth starting portion 551a is parallel to the fourth edge 511d. The fourth ending portion 551b is parallel to the second edge 511b. The fourth connecting portion 551c is parallel to the first edge 511a and connected with the fourth starting portion 551a and the fourth ending portion 551b. The length of the fourth ending portion 551b is less than or equal to that of the fourth starting portion 551a. A fourth fixing portion 56d is formed between the second through hole 510 and the angular part or space between the fourth ending portion 551b and the fourth connecting portion 551c. The fourth starting portion 551a and the fourth connecting portion 551c are on the outer side of the third slot 54, i.e., the fourth starting portion 551a and the fourth connecting portion 551c are closer to the fourth edge 511d and the first edge 511a than the third slot 54. A third L-shaped spring portion 57c is formed between the third slot 54 and the fourth slot 55. The first starting portion 521a and the first connecting portion 521c are on the outer side of the fourth slot 55, i.e., the first starting portion 521a and the first connecting portion 521c are closer to the first edge 511d and the first edge 511a than the fourth slot 55. A fourth L-shaped spring portion 57d is formed between the fourth slot 55 and the first slot 52.

Each fixing portion (56a, 56b, 56c, 56d) defines a first cutout 561 at the edge of the second through hole 510 corresponding to the respective second locating pins 413. Each fixing portion (56a, 56b, 56c, 56d) further defines two holes 563 set around the first cutout 561. The two holes 563 are corresponding to the grooves 414. The fixing portion further (56a, 56b, 56c, 56d) defines a second cutout 562 around the second through hole 510 for fixing one end of the coils 42 therein.

A peripheral portion 58 is formed between the edges (511a, 511b, 511c and 511d) and the starting portions (521a, 531a, 541a and 551a). Four holes 582 corresponding to the respective first locating pins 303 are defined in the peripheral portion 58 in four corners. The peripheral portion 58 is fastened to the top side of the fixed barrel 30 by engagement of the holes 582 with the respective first locating pins 303.

Most of the structure of the second flat spring plate 50a is similar to that of the first flat spring plate 50, except that, the first flat spring plate 50 includes a first terminal 501 perpendicular to one side thereof and the second flat spring plate 50a includes a second terminal 502 perpendicular to one side thereof.

The lens actuator 10 may only have a first flat plate 50 or a second flat plate 50a.

The board 60 is corresponding to the housing 20 to form a corresponding room to accommodate the fixed barrel 30, the lens barrel 40, the first flat spring plate 50a and the second flat spring plate 50a. The board 60 comprises a body 61 covered over the second flat spring plate 50a on the bottom side of the housing 30, an through hole 62 corresponding to the second accommodating room 412 of the lens barrel 41, four holes 63 respectively fastened to the first locating pins 303 at the bottom side of the fixed barrel 30.

The first terminal 501 is mounted in the terminal groove 305 of the fixed barrel 32 and electrically connected to the coils 42. The second terminal 502 is electrically connected to the coils 42.

When an electric current is applied to the terminals 501, 502 and the coils 42, the coils 42 are excited to act upon the magnets 34, thereby receiving a magnetic force to drive the lens barrel 42 to linearly move along its central axis.

When electric current is cut off from the terminals 501, 502, the first flat spring plate 50 and the second flat spring plate 50a impart a restoring force to the lens barrel 41, thereby returning the lens barrel 41 to its former position.

Furthermore, the housing 20 and the board 60 protect the lens barrel 41 and image sensor (not shown) against dust.

While certain embodiments have been described and exemplified above, various other embodiments will be apparent to those skilled in the art from the foregoing disclosure. The present invention is not limited to the particular embodiments described and exemplified but is capable of considerable variation and modification without departure from the scope of the appended claims.

What is claimed is:

1. A lens actuator for driving a lens to move, comprising:
a lens barrel for accommodating the lens;
a coil warped around the lens barrel;
a fixed barrel, the lens barrel being received in and linearly movable relative to the fixed barrel;
a plate shaped body including a through hole defined in a center thereof and a peripheral portion around the through hole, the flat spring plate's peripheral portion being fixed to one end of the fixed barrel,
wherein the fixed barrel is comprised of a permanent magnetic material.

2. The lens actuator as claimed in claim 1, wherein the fixed barrel comprises a main body and a plurality of first locating pins protruding out therefrom.

3. The lens actuator as claimed in claim 2, wherein a cross section of the main body has a shape selected from the group consisting of square, round, triangle, pentagon and hexagon.

4. The lens actuator as claimed in claim 3, further comprising a second plate shaped body including a through hole defined in a center thereof and a peripheral portion around the through hole, the peripheral portion of the second plate shaped body being fixed to the fixed barrel.

5. The lens actuator as claimed in claim 4, further comprising a housing, the housing including a accommodating room to accommodate the fixed barrel, the lens barrel, and the first and second plate shaped bodies therein.

6. The lens actuator as claimed in claim 4, wherein the housing is comprised of a material selected from the group consisting of ferronickel alloy, electrically conductive plastic, surface conductive material and electrically conductive glass.
